(19) United States
(12) Patent Application Publication
(10) Pub. No.: US 2010/0328102 A1
(43) Pub. Date: Dec. 30, 2010

(54) INTERACTIVE CONTROL SYSTEM FOR CONTROLLING AN URBAN AND EXTRA-URBAN ROAD NETWORK SUBJECTED TO SAFETY AND FEATURE-RELATED STANDARDS AND/OR RESTRICTIONS

(76) Inventor: Saulle Mattei, Casalecchio di Reno (IT)

Correspondence Address: BIRCH STEWART KOLASCH & BIRCH, PO BOX 747, FALLS CHURCH, VA, 22040-0747, US

(21) Appl. No.: 12/866,986

(22) PCT Filed: Dec. 24, 2008
(86) PCT No.: PCT/IB2008/055529

§ 371 Date: Aug. 10, 2010

(30) Foreign Application Priority Data
Mar. 18, 2008 (SM) SM-A-20080017

(51) Int. Cl. G08G 1/09; G01S 19/42

(52) U.S. Cl. 340/905; 342/357.25

(57) ABSTRACT

The present invention generally concerns the technical field of road engineering and road safety and relates to an interactive control system (1) for controlling an urban and extra-urban road network (R) subjected to standards and/or restrictions, comprising: road signage means (2) distributed throughout the network (R) for indicating such standards and restrictions; a plurality of remote devices (3) designed to be installed on motor vehicles (A); first detection means (4) for collecting first data about traffic conditions; a main control unit (5) connected to the first detection means (4) and to the road signage means (2) for processing the first data and providing pieces of information to users; transceiver means (6) associated with the road signage means (2) for reception/transmission of the first data from the road signage means (2) to the remote devices (3); the road signage means (2) and the remote devices (3) include first and second interactive means (8, 9) respectively for displaying images and/or words to provide information to the users.

### FIELD OF THE INVENTION

The present invention generally concerns the technical field of road engineering and road safety and relates to an interactive control system for controlling an urban and extra-urban road network.

More particularly, the present invention is finalized to provide a control system that offers to a vehicle driver enhanced usability of the data concerning a road section covered by the vehicle, while using as many road signs or less.

### BACKGROUND ART

In any country, road networks generally have road signs for providing indications to the users in view of smoothing and controlling traffic flow while limiting accidents or other danger situations.

Thus, road signs are mainly divided into two groups, road markings and road signs. The first group includes colored words and lines applied on roadways for the users to locate, for instance, stop points, roadway separation, rest areas, sections in which passing or roadway changes are allowed, to indicate that turning is allowed or prohibited, or else.

On the other hand, the second group essentially comprises posts of various types, i.e. traffic lights and other ground lights. Sign posts include, for example, those that indicate the presence of obstacles, stop points, narrowing or widening roadways, various types of warnings, speed limits in the road section being covered, names of streets, places, towns, indications of directions to follow to reach specific places or else.

Traffic lights and ground lights in general assist traffic control at critical points, such as crossroads or provide more effective indications, as compared with the above mentioned signs, about the presence of dangerous sections, such as particularly sharp curves or a railroad.

Thus, road signs are provided with the purpose of imparting as extensive information as possible to users in order for them to drive the vehicle with maximum safety for themselves and others, and to be always informed as conveniently as possible about what concerns the road sections being covered.

For the data to be constantly updated, dynamic road signs are also known, i.e. road signs whose indications can be changed in response to specific conditions. As an example of the above, signs are provided that show different speed limits in high traffic or bad weather conditions.

Nonetheless, this cannot be considered to be sufficient, because the driver is required to constantly take care of the indications on the road signs, which does not always occur due to lack of expertise, to an excessive number of road signs, to inappropriate arrangement of the latter, which can make them difficult to read in certain conditions or because user's attention is captured by surrounding facts or events such as dangerous driving by other users.

In an attempt to obviate such drawback, U.S. Pat. No. 6,213,401 B1 discloses a speed detection system in which the road signage means include a barcode giving the required information whereas a device is provided in the vehicle for reading such code and displaying the data being read on a screen or monitor available to the user.

With the evolution of technology, this system was replaced by transceivers that transmit information to a special device provided in the vehicle, which displays the received data on a screen. Examples of the above devices are disclosed in U.S. Pat. No. 7,010,397 B1 and U.S. Pat. No. 6,864,784 B1. Both patents, in spite of their differences, relate to in-vehicle devices that communicate by wireless means with a communications network arranged along the road network to receive data about what is indicated by the road signs. In this respect, devices are also known that not only display the received data, but also compare it with the vehicle speed and automatically cause it to decrease if the vehicle drives at a speed that exceeds the limit for that road section. Examples of the above devices are disclosed in U.S. Pat. No. 6,166,658 B1 and DE 19951213.

However, the above mentioned patents only relate to static road signage means, in which the displayed information cannot be changed, with a communications network added thereto for the users to receive updated information, often in contrast with the signs.

Concerning safety, patents are also known, according to which the in-vehicle device processes information from various sensors in the vehicle to assess the quality of the driving style of the driver. If the collected data collides with the safety standards and/or restrictions resulting from the wireless communications network over the road network, then these devices provide indications thereof to the other drivers or the police using light signals emitted from in-vehicle lights or by transmitting specific data to the communications network. Examples of the above are disclosed in U.S. Pat. No. 6,643,578, U.S. Pat. No. 6,502,035 and in Patent Application US 2007/0242337.

Nevertheless, these solutions also suffer from the drawback that the signs display static information. A further example is disclosed in Patent Application EP 1 313 078, in which a wireless communications network is used to transmit road condition data, such as obstacles or else, to in-vehicle devices. Such indications are unrelated from those provided by the road signs that do not consider random and/or unexpected events.

This involves the additional drawback that the user might be confused by the apparent contradiction between the displayed and the received information.

Also, a problem still exists concerning certain situations that are not covered by any one of the above prior art documents. For example, areas or streets are known in which traffic is restricted or accesses are controlled at least at certain times. Access control is often complex and requires the provision of special signs bearing static information and indicating rules and rates, if any. Due to the complexity of rules, these signs bear a large amount of information and cannot be read by a driver from the vehicle, wherefore he/she generally has to stop, get out of the vehicle and read the information.

Similar problems arise in pay parking or disk parking lots. Parking durations and/or rates may change according to specific times and days. In this case again, signs are provided, but the driver has to stop the vehicle and get out of it to read them.

### DISCLOSURE OF THE INVENTION

The main object of the present invention is to obviate the above drawbacks by providing an interactive control system for controlling a road network that allows the users to be constantly up to date about standards and/or restrictions, even of temporary nature, about the road network.

A further object is to provide a control system that allows the user to quickly and conveniently obtain such information.

Another object is to provide a control system that affords improved road safety without creating confusion in users.

Yet another object is to provide a control system that is particularly suitable for use in indicating and managing areas with restricted traffic or controlled access, parking lots and the like.

These and other objects, as better explained hereafter, are fulfilled by a control system for controlling an urban and extra-urban road network subjected to safety and feature-related standards and/or restrictions, as defined in the main claim.

Particularly, this control system comprises:
road signage means distributed throughout the network for indicating said safety and feature-related standards and restrictions;
a plurality of remote devices designed to be installed on motor vehicles, each being equipped with means for detection and storage of first data, concerning static and dynamic parameters of the vehicle on which it is provided, such as current speed, average speed, parking time, turns, roadway changes and the like;
at least one main control unit connected to said road signage means for providing information to users over at least part of the road network, said road sign means including first interactive means for displaying images and/or words to provide said information to said users, and said remote devices having second interactive means for displaying said information to each single user;
transceiver means associated with said road signage means for reception/transmission of at least said first data from said road signage elements to said remote devices;
at least one electronic processing unit in each of said remote devices for processing and comparing said first data concerning static and dynamic parameters of the vehicles with said information to generate second data to be transmitted to said main control unit, said second data including data concerning the behavior of said user in response to said features such as the parking duration of the vehicle in a restricted parking zone, access to a restricted traffic zone and the like.

An immediately apparent advantage consists in the simultaneous availability of ready-to-use updated information both in road signage and within the vehicle. This involves a reduction of the number of road signs installed, preventing confusion in users, and further allows the information to be controlled and changed anytime, according to environmental and traffic conditions or else.

Suitably, the interactive means include at least one display that, particularly in the case of the second interactive means, may be of touch screen type, to allow the user to enter or request particular information through the remote device. This is particularly useful if the user wants to scroll information, such as in the case of parking rates. Furthermore, the user can enter information such as his/her personal details or the parking rate payment details.

Subscription or automatic payment arrangements may be also provided, to allow the user to be no longer concerned with such operations when entering a parking lot.

According to one aspect of the invention, the electronic processing unit of the remote devices processes third data about traffic conditions to be transmitted to the main control unit.

Generally, the third data may include data concerning indications of current conditions such as the presence of obstacles, traffic delays, tailbacks, bad weather conditions, temporary no parking areas, limited access zones, restricted parking zones and the like, whereas the second data may include data concerning the events in which such standards and/or restrictions have been exceeded, such as exceeded speed limits, a passing event in a no passing zone, a prohibited turn, unauthorized access to restricted or prohibited traffic zones, parking beyond authorized times and the like.

In any case, as mentioned above, the first data may include data concerning a user's behavior in response to features such as the parking duration in a restricted parking zone, authorized access to a restricted traffic zone and the like.

Thus, the interactive control system of the invention substantially provides constantly updated information to the road network users both via the road signs and via an in-vehicle remote device. This particularly allows to make convenient and full use of the information even in case of difficultly reachable information, such as those associated with the management of parking and limited access zones. Moreover, the user can be constantly up to date about the conditions of the road network even when he/she could not perceive the indications of the road signage means, due to carelessness or other reasons.

According to another aspect of the invention, communication between the remote device and the road signage means occurs in both ways, allowing the authorities to be warned about any violation of the road code for improved safety or about any other violation.

Furthermore, it may be envisaged that the police is equipped with in-vehicle devices that can communicate with the in-vehicle remote devices of users to check not only their driving behavior but also, for example, the owner's data to make crosschecks, and check that the road taxes and insurance have been correctly paid or whether a vehicle theft report has been filed.

This would allow the police to increase the number of controls while avoiding the need of road blocks which are both annoying and time-consuming for users and dangerous for the police.

### BRIEF DESCRIPTION OF THE DRAWINGS

Further features and advantages of the invention will be more apparent upon reading of the detailed description of a few preferred, non-exclusive embodiments of an interactive control system of the invention, which are described as non-limiting examples with the help of the annexed drawing, in which

FIG. 1 is a diagrammatic view of an interactive control system for controlling a road network according to the invention.

### DETAILED DESCRIPTION OF A PREFERRED EMBODIMENT

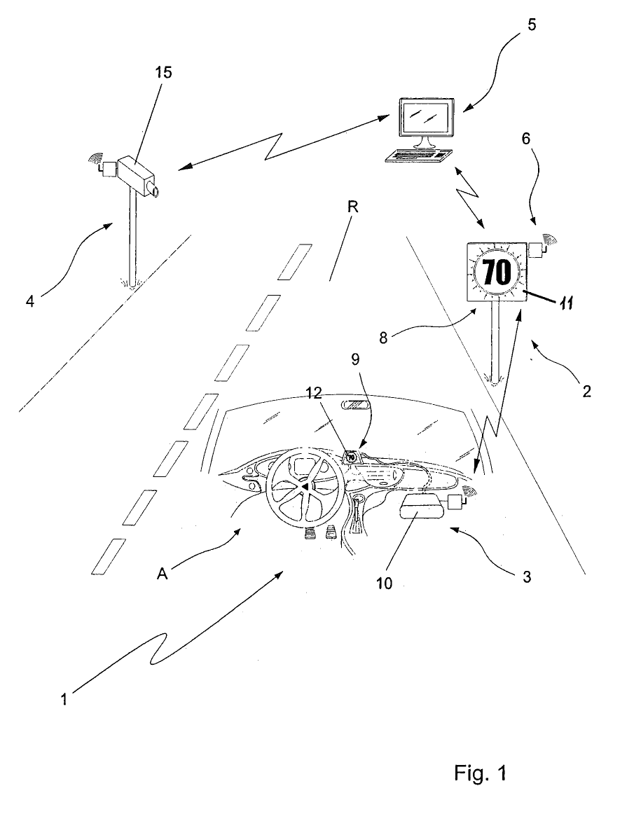

FIG. 1 shows the interactive control system 1 for controlling an urban and extra-urban road network subjected to safety and feature-related standards and/or restrictions according to the invention. Firstly, it comprises road signs or signage means 2 distributed all over the network R for indicating said safety and feature-related standards and restrictions.

A plurality of remote devices are also provided, which are designed to be installed on motor vehicles A, each being equipped with means for detection and storage of first data, concerning static and dynamic parameters of the vehicle on which it is provided, such as current speed, average speed, parking time, turns, roadway changes and the like.

Suitably, the present interactive control system 1 comprises at least one central control unit 5 connected to the road signs 2 for providing information to users over at least part of the road network R. These road sign means 2 include first interactive means 8 for displaying images and/or words to provide information to the users. Also, the remote devices 3 have second interactive means 9 for displaying information for each user, while he/she comfortably sits in his/her own vehicle.

Thus, the interactive control system 1 comprises transceiver means 6 associated with the road signs 2 for reception/transmission of information between the road signs 2 and the remote devices 3.

The latter also include at least one electronic processing unit 10 for processing and comparing the first data concerning static and dynamic parameters of the vehicles with this information to generate second data to be transmitted to the main control unit 5. Such second data including data concerning a user's behavior in response to features, e.g. the parking duration of the motor vehicle A in a restricted parking zone and/or access to a restricted traffic zone and the like.

As mentioned above, an immediately apparent advantage consists in the simultaneous availability of ready-to-use updated information both in road signs and within the vehicle. Thus, a smaller number of road signs may be used, and the transmitted information may be controlled and changed any time. This particularly allows convenient and full use of the information in case of difficultly reachable information, such as that associated with the management of parking and limited access zones.

According to one aspect of the invention, the control system comprises first detection means 4 for collecting third data about traffic conditions along the road network R.

Furthermore, the central control unit 5 is connected to the first detection means 4 for processing the third data and providing relevant information to users over at least part of the road network R.

As mentioned above, this provides the advantage of simultaneously obtaining ready-to-use updated information both in road signs and within the vehicle, which allows the device of the invention to obviate prior art drawbacks.

The above clearly shows that, in the preferred embodiment, the system that provides communication between the central unit, the dynamic road signs and the remote devices advantageously has a two-way operation. Particularly, communications between the road signs and the remote devices typically occur via a wireless transceiver unit, whereas connection between the road signs and the central control unit may be provided by cables or wireless transceiver units.

The interactive means 8, 9 generally include at least one display 11, 12 that, in the case of the second interactive means 9, may advantageously be of touch screen type, to allow the user, as mentioned above, to enter or request particular information through the remote device.

The value and usefulness of the control system 1 of the invention particularly consist in that the information generated on the basis of the first data is constantly up to date and appears simultaneously both on the road signs 2, hence displaying dynamic and not static information and on the remote devices 3 within the motor vehicles A.

Thus, the third data includes data concerning instant conditions such as the presence of obstacles, traffic delays, tailbacks, bad weather conditions, temporary no parking areas, limited access zones, restricted parking zones and the like.

For enhanced road safety, each remote device 3 may be arranged to transmit second data to the central control unit 5, which second data concerns events in which the standards and/or restrictions have been exceeded. Thus, each of the remote devices 3 comprises means for storage of the first, second and/or third data.

It may be also envisaged that the police, as mentioned above, is equipped with in-vehicle devices that are able to communicate both with the operation headquarters and with the in-vehicle remote devices of users to check whether the cars have been stolen, that road taxes have been paid, that cars are insured and especially whether the user has committed punishable infringements.

This would allow them to increase the number of controls while avoiding the need of road blocks which are both annoying and time-consuming for users and dangerous for the police.

It shall be noted that the present control system 1 is particularly designed for use in the management of the road network R. For instance, it can be used in the management and control of accesses to restricted traffic zones, restricted parking areas and pay parking lots. Thus, for instance, the second data includes data concerning the parking duration of the motor vehicle A in a restricted parking zone, authorized access to a restricted traffic zone and the like.

As a complement to the information required for all the above features, the first data may also include second information concerning the manufacturer, the model and number plate of the vehicle in which the remote devices are installed, for easy identification thereof.

According to another aspect of the invention, the electronic processing unit 10 of the remote devices 3 is suitably connected to means for identification of the vehicle user that can include, for example, a fingerprint detector or a detector of similar anthropologic parameters and/or an alphanumeric keypad. Therefore, the first data also include user identity indications.

Each of the remote devices 3 obviously includes second detection means for acquiring first data. These second means, not shown, generally include one or more sensors for determining vehicle speed, vehicle position in the roadway, proximity with obstacles or other vehicles and other similar data. Furthermore, the second detection means include vehicle locating means, generally including a GPS receiver so that the first data can also include a vehicle position indication.

Concerning the first detection means 4, they generally include a plurality of sensors and/or one or more cameras 15 distributed along the road network R and operably connected to the central unit 5 and/or to one of more displays available to an operator.

In operation, the central control unit 5 controls the display of information concerning the safety and feature-related standards and/or restrictions of the road network R on the road signage means 2 and the remote devices 3.

The first detection means 4 are useful in the supervision of the conditions of the road network R to locate situations or events that might lead to changes in the information provided to the users.

For example, in case of accidents or unexpected obstacles, the central control unit 5 monitors the display of relevant information about speed limits and the presence of accidents and/or obstacles to appropriate road signage means 2 and, via the transceiver means 6, to the relevant remote devices 3.

Particularly, it can be envisaged that a speed limit reduction is indicated at an appropriate distance from the accident or obstacle, which will gradually decrease until the accident and/or obstacle is reached. In case of tailbacks, the indication will be obviously anticipated as the tailgate grows.

According to another aspect of the invention, the information may also indicate mandatory turns or prohibited access to the next section of the road network R to avoid excessive tailgates and hence control traffic.

As is apparent, the rules involve a number of possible situations, each generating one different type of information generated by the central control unit 5 and provided to the users through the road signage means 2 and the remote devices 3.

Generally, the information provided to the users via the interactive means 8; 9 concern for instance the current speed limit, a temporarily narrowed section of the roadway, tailbacks, temporary obstacles, currently prohibited access to the road section being covered.

As mentioned above, according to another aspect of the invention, the control system 1 is used to improve road safety by warning the competent authorities and/or other users of any hazardous behavior of a particular user.

For this purpose, the local electronic processing unit 10 in the remote devices 3 processes the second data received from the road signage means 2 and compares it with the first data including the static and/or dynamic parameters of the motor vehicle A, i.e. the user's driving behavior. If such behavior involves a road code violation, then processing of the second data to be transmitted to the main control unit 5 provides a prompt indication thereof to the other users and the police, to allow the other users to avoid danger situations and the police to stop and inflict penalties to the undisciplined user.

A particular advantage of the invention is that the control system 1 also allows more convenient use of other information and services over the road network R.

It is increasingly frequent that cities include zones with restricted traffic at certain times of the day. Here, the control system 1 of the invention provides constantly up to date information to users concerning the admission to such zones at a certain time. Furthermore, the system may suitably control accesses and indicate unauthorized accesses for fining.

Also, concerning restricted parking areas, as mentioned above, there may be disk parking areas in which parking is allowed for variable time intervals during the day or the parking rate changes during the day, or parking areas that at times have a disk parking operation, at other times a pay parking operation and at yet other times a free parking operation. Here again, the control system 1 provides correct information to the user and does not require him/her to watch the road signs which, in this case, would bear such a large amount of information as to force the user to stop the motor vehicle A and get out of it to read such information.

Furthermore, in addition to the indication of unlawful behaviors such as parking beyond permitted limits, user identification may also involve automatic payment. Indeed, the user may be registered with an automatic payment service which charges his/her current account, credit card or the like. This provides the advantage of allowing automatic parking and payment, to release the user of any concern therefor, and improve the service.

According to yet another aspect of the invention, the remote devices 3 include means for connection to a mobile-telephony network, generally consisting of a SIM card from a mobile operator.

Below there is described a non limiting example of use of the means for connection to a mobile telephony network for the control of accesses to restricted traffic zones, even in inner cities with environmental impact restrictions for installation of access control systems.

A signal equivalent to that of automatic motorway accesses might trigger the request to enter login parameters. The, the remote device 3 will indicate whether the user is allowed to enter or not and whether a toll has to be paid. In this case, the remote device 3 will send a SMS to the service center, which enables access and accordingly charges the SIM card.

Parking fees may be obviously also paid. In this case, trade agreements may be envisaged between parking managers and mobile-telephony operators, where parking managers provide free area data and possibly accept customer reservations. Here, the SIM card ID code or telephone number might be used as a user ID.

It should be also noted that while emergency calls can be currently made even without a SIM card, these are voice calls only. The presence of a SIM card in the remote device 3 allows the transmission of data to the police.

The above disclosure clearly shows that the interactive control system of the invention fulfills all the intended objects, and particularly allows the users to be constantly up to date about standards and/or restrictions, even of temporary nature, about the road network.

Namely, through the main embodiment and the variants, the invention improves road safety and allows users to quickly and conveniently reach this information, particularly concerning the indication and control of restricted traffic or controlled access zones, parking areas and the like.

It shall be understood that the control system of this invention is susceptible of a number of further changes and variants, within the inventive principle as disclosed in the appended claims.

Furthermore, all the details may be replaced by technically equivalent elements or components, and any size, shape and material may be used according to various needs.

1-15. (canceled)

16. An interactive control system for controlling an urban and extra-urban road network subjected to safety and feature-related standards and restrictions, comprising:
road signs distributed all over the network for indicating said safety and feature-related standards and restrictions;
a plurality of remote devices designed to be installed on motor vehicles, each being equipped with electronic devices for detecting and storing first data, which concern static and dynamic parameters of the vehicle on which it is provided, such as current speed, average speed, parking time, turns, roadway changes and the like;
at least one central control unit connected to said road signs for providing information to users over at least part of the road network, said road signs including first interactive devices for displaying images and/or words to provide said information to said users, and said remote devices having second interactive devices for displaying said information to each user;
transceiver electronic circuits associated with said road signs for reception/transmission of at said information between said road signs and said remote devices;
at least one electronic processing unit in each of said remote devices for processing and comparing said first data concerning static and dynamic parameters of the vehicles with said information to generate second data to be transmitted to said central control unit, said second data including data concerning the behavior of said user in response to said features such as the parking duration of the motor vehicle in a restricted parking zone, access to a restricted traffic zone and the like.

17. A control system as claimed in claim 16, wherein it comprises first detection units for acquiring third data about traffic conditions along the road network.

18. A control system as claimed in claim 17, wherein said central control unit is connected to said first detection units for processing at least said third data and providing relevant information to users over at least part of the road network.

19. A control system as claimed in claim 17, wherein said third data includes data concerning current conditions such as the presence of obstacles, traffic delays, tailbacks, bad weather conditions, temporary no parking areas, limited access zones, restricted parking zones and the like.

20. A control system as claimed in claim 16, wherein said second data includes data concerning events in which said standards and restrictions have been exceeded, such as exceeded speed limits, a passing event in a no passing zone, a prohibited turn, unauthorized access to restricted or prohibited traffic zones, parking beyond authorized times and the like.

21. A control system as claimed in claim 16, wherein each of said remote devices comprises devices for storage of at least said first and said third data.

22. A control system as claimed in claim 16, wherein said first data also comprises second information concerning the manufacturer, the model and number plate of the vehicle in which said remote devices are installed.

23. A control system as claimed in claim 16, wherein said electronic processing unit has devices for identifying the user that uses the motor vehicle, said first data also including an indication of the user's identity.

24. A control system as claimed in claim 23, wherein said identification devices include one or more fingerprint detectors or detectors of similar anthropologic parameters and/or one or more alphanumeric keypads.

25. A control system as claimed in claim 16, wherein each of said remote devices comprises second detection units for acquiring said first data.

26. A control system as claimed in claim 25, wherein said second detection units include one or more of speed sensors of the vehicle, position sensors for detecting the position of the vehicle in the roadway, proximity sensors for detecting the proximity of the vehicle to obstacles or other vehicles, devices for locating the vehicle.

27. A control system as claimed in claim 26, wherein said devices for locating the position of the vehicle include a GPS receiver.

28. A control system as claimed in claim 17, wherein said first detection units include one or more cameras distributed along said road network and operably connected to one of more displays available to an operator.

29. A control system as claimed in claim 16, wherein said information data comprise one or more of the following indicatons:
the current speed limit in the road section in which said road signs are located;
a temporarily narrowed roadway in the road section in which said road signs are located;
the presence of tailbacks in the road section in which said road signs are located;
the presence of temporary obstacles in the road section in which said road signs are located;
the presence of a currently prohibited access to the road section covered by the motor vehicle;
the presence of access to a zone having at least temporary traffic restrictions;
the presence of the current disk parking duration admitted in a parking lot within the road section covered by the motor vehicle;
the presence of the current parking rate in a parking lot within the road section covered by the motor vehicle.

30. A control system as claimed in claim 16, wherein it comprises electronic devices for connection to a mobile-telephony network.
